(19) United States
(12) Patent Application Publication
(10) Pub. No.: US 2015/0052447 A1
(43) Pub. Date: Feb. 19, 2015

(54) REMOTE DESKTOP SHARING FOR VEHICLE DISPLAYS

(71) Applicant: Deere & Company, Moline, IL (US)

(72) Inventor: Kondekar Ritesh, Mumbai (IN)

(21) Appl. No.: 14/306,727

(22) Filed: Jun. 17, 2014

(30) Foreign Application Priority Data
Aug. 19, 2013 (IN) 2698/MUM/2013

(51) Int. Cl. H04L 29/08; H04L 12/24

(52) U.S. Cl. CPC H04L 67/125; H04L 41/22
USPC 715/740

(57) ABSTRACT

A system and method to remotely share a display screen are provided. Packets on a data bus may be detected with a bus sniffer, where the packets are transmitted by a display controller to a first display device over the data bus. The packets may include information describing a graphical user interface displayed in the first display device. A representation of the graphical user interface may be generated in a memory from the packets. The representation of the graphical user interface in the memory may be shared with a second display device over a network with a desktop sharing system. The second display device may display a copy of the graphical user interface based on the representation of the graphical user interface shared by the desktop sharing system.

This application claims priority under 35 U.S.C. §119 to India Patent Application No. 2698/MUM/2013, filed Aug. 19, 2013, and entitled “REMOTE DESKTOP SHARING FOR VEHICLE DISPLAYS,” the entire contents of which are hereby incorporated herein by reference.

### BACKGROUND

1. Technical Field

This application relates to displays and, in particular, to sharing display screens.

2. Related Art

Vehicles sometimes include one or more display devices. The vehicle display devices may be used to control the vehicle or aspects of the vehicle. Alternatively or in addition, the display devices may display data about the vehicle or aspects of the vehicle. For example, the vehicle display may display a graphical user interface through which an operator of the vehicle controls a climate control system or some other system of the vehicle.

### SUMMARY

In one embodiment, a system is provided for remote desktop sharing of a vehicle display device. The system may include a bus sniffer, a memory, a user interface generator, a network interface, and a graphics sharing module. The bus sniffer may detect packets on a vehicle data bus as the packets pass over the vehicle data bus between a display controller and a first display device. The packets may include information that describes a graphical user interface displayed in the first display device. The user interface generator may generate a representation of the graphical user interface in the memory from the packets detected by the bus sniffer. The network interface may communicate over a network to a second display device. The graphics sharing module may communicate the representation of the graphical user interface to the second display device over the network via the network interface. The second display device may display a copy of the graphical user interface based on the representation of the graphical user interface that is communicated to the second display device by the graphics sharing module.

In one embodiment, an apparatus for remote desktop sharing is provided. The apparatus may include a bus sniffer, a memory, a user interface generator, and a graphics sharing module. The bus sniffer may detect packets transmitted by a display controller over a data bus to a first display device. The packets may include information related to a graphical user interface displayed in the first display device. The user interface generator may generate a representation of the graphical user interface in the memory from the packets detected by the bus sniffer. The graphics sharing module may communicate the representation of the graphical user interface from the apparatus to the second display device over a network. The second display device may display a copy of the graphical user interface based on the representation of the graphical user interface communicated to the second display device by the graphics sharing module.

In one embodiment, a method to remotely share a desktop is provided. Packets on a data bus may be detected with a bus sniffer, where the packets are transmitted by a display controller to a first display device over the data bus. The packets may include information describing a graphical user interface displayed in the first display device. A representation of the graphical user interface may be generated in a memory from the packets. The representation of the graphical user interface in the memory may be shared with a second display device over a network with a desktop sharing system. The second display device may display a copy of the graphical user interface based on the representation of the graphical user interface shared by the desktop sharing system.

### BRIEF DESCRIPTION OF THE DRAWINGS

The embodiments may be better understood with reference to the following drawings and description. The components in the figures are not necessarily to scale. Moreover, in the figures, like-referenced numerals designate corresponding parts throughout the different views.

FIG. 1 illustrates a system for remote desktop sharing of a display device included in a vehicle;

FIG. 2 illustrates a flow diagram of example logic of a bus sniffer;

FIG. 3 illustrates a flow diagram of example logic of a user interface generator; and

FIG. 4 illustrates a flow diagram of example logic of a system for remote desktop sharing of a display device.

### DETAILED DESCRIPTION

By way of example, a gateway may be provided that facilitates generating a remote display for a vehicle. The vehicle may include a display device and a corresponding display controller, where the display device and the display controller communicate with each other over a vehicle data bus. For example, the vehicle data bus may comply with ISO 11783 or a similar standard. ISO 11783, also referred to as ISOBUS, specifies a serial data network for control and communications on forestry and/or agricultural tractors and implements. ISO 11783 is based on the SAE (Society of Automotive Engineers) J1939 standard, which includes a CAN (Controller Area Network) Bus and similar types of communication buses. The display controller and the display device may communicate over the vehicle data bus using J1939 or a similar standard. In some examples, the display device may operate as a virtual terminal (VT) as described by ISO 11783 or other virtual terminal protocols.

The gateway may couple to the vehicle data bus. The gateway may include a bus sniffer, a user interface generator, and a graphics sharing module. The bus sniffer may detect packets transmitted by the display controller over the vehicle data bus to the display device. The packets may include information related to a graphical user interface displayed in the first display device. For example, the packets may conform to a virtual terminal protocol that enables the display controller to describe and control the graphical user interface displayed by the display device. For example, the packets may include an object pool published by the display controller to the display device. The object pool may describe user interface controls to be displayed in the graphical user interface. Alternatively or in addition, the packets may include runtime updates to the graphical user interface resulting from user input and/or from changes requested by the display controller. The user interface generator may generate and/or update a representation of the graphical user interface in memory from the packets detected by the bus sniffer. For example, the representation of the graphical user interface may be an image of the graphical user interface. The representation of the graphical user interface may serve as a copy of the user interface intended to be displayed and/or displayed on the display device. The graphics sharing module may communicate the representation of the graphical user interface from the gateway to a remote display device over a network, such as a wireless and/or cellular network. The remote display device may display a copy of the graphical user interface displayed on the display device of the vehicle based on the representation of the graphical user interface shared with the remote display by the graphics sharing module. Runtime updates to the graphical user interface are updated in the memory of the gateway by the user interface generator and shared with the remote display device by the graphics sharing module so that the copy of the graphical user interface displayed by the remote display device may be appear to be a copy of the graphical user interface displayed by the display device of the vehicle.

One technical advantage of such a gateway is that regardless of the type of the display device on the vehicle, the user interface displayed on the display device may be shared with a remote display device. For example, the display device may not necessarily have any remote sharing functionality. Another technical advantage of such a gateway is that the display controller does not need to have any remote sharing functionality either. Accordingly, existing vehicles may be extended to support remote sharing functionality by plugging the gateway into the vehicle data bus.

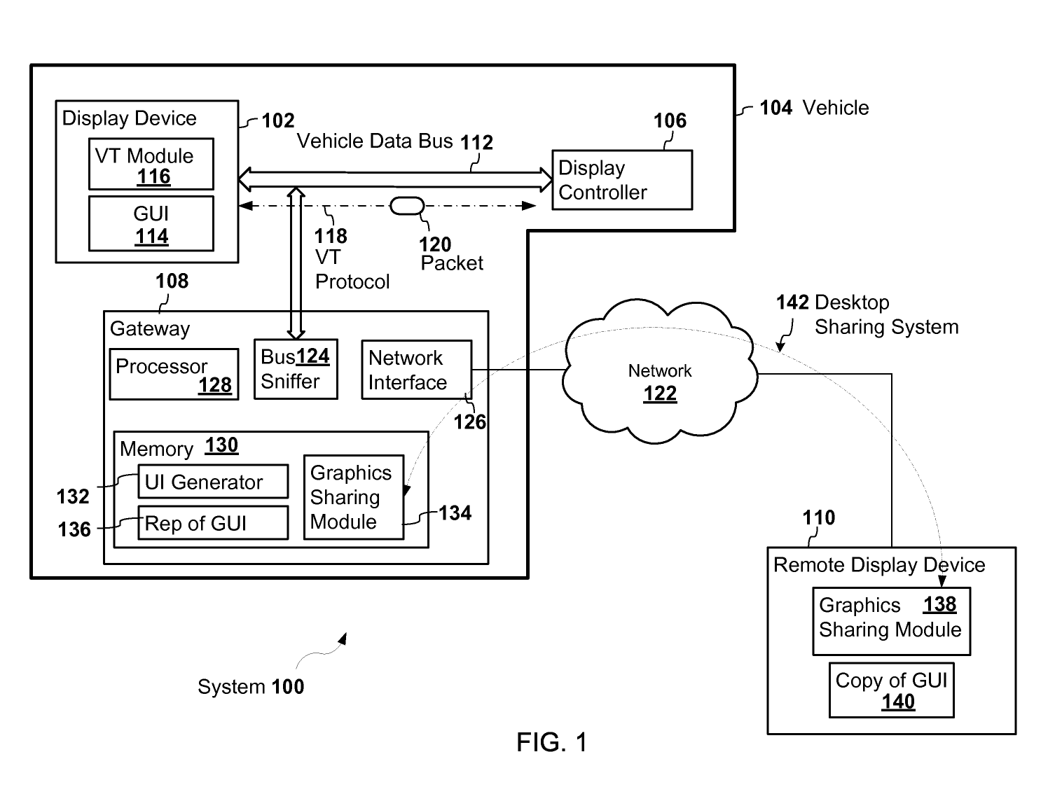

FIG. 1 illustrates a system 100 for remote desktop sharing of a display device 102 included in a vehicle 104. The system 100 may include the display device 102, a display controller 106, a gateway 108, and a remote display device 110.

The display controller 106 may be any component that controls the display device 102 over a vehicle data bus 112. Examples of the display controller 106 include an electronic control unit (ECU), a speed control unit, a human-machine interface, an embedded system, or any other device configured to transmit data describing a graphical user interface (GUI) 114 over the vehicle data bus 112.

The vehicle data bus 112 may be a communications network that interconnects components of the vehicle 104. In some examples, the vehicle data bus 112 may have specialized features for vehicle control, such as assurance of message delivery, assured non-conflicting messages, assured time of delivery, relative low cost, resilience in the presence of electromagnetic fields, redundant routing, and/or other characteristics. The vehicle data bus 112 may include a specialized communications network that provides such specialized features. The vehicle data bus 112 may include a communications network configured to facilitate communication between microcontrollers and devices without a host computer. The vehicle data bus 112 may be configured to facilitate adding and removing devices that read and/or write data from and/or to the vehicle data bus 112. Examples of the vehicle data bus 112 may include a controller area network (CAN) bus, a local interconnect network (LIN), an ISO 9141/11783 compliant network, a J1850/J1939 compliant network, and an Ethernet network.

The display device 102 may be any electro-optical device for displaying a graphical user interface. Examples of the display device 102 may include a liquid crystal display (LCD), an organic light-emitting diode (OLED) display, a cathode ray tube (CRT) display, an electro-luminescent display, a plasma display panel (PDP), a vacuum florescent display (VFD), a projector, a laptop computer, a tablet computer, a mobile phone, or any other type of display device.

To display the graphical user interface 114 in the display device 102, the display device 102 may include a virtual terminal module 116. The virtual terminal module 116 may be a component that includes an implementation of a virtual terminal protocol 118 at the display device 102.

The virtual terminal protocol 118 may be any communications protocol for remote definition and/or control of graphical user interfaces, such as the graphical user interface 114 displayed in the display device 102. In some examples, the virtual terminal protocol 118 may be any communications protocol that defines and/or controls user interface controls in a graphical user interface over a network, such the vehicle data bus 112. The virtual terminal protocol 118 may be any past, present, or future published standard, proprietary standard, or any other type of standard for establishing and/or controlling a virtual terminal.

In one example, the virtual terminal protocol 118 may be any version of ISO 11783-6 (International Organization for Standardization's standard entitled “Tractors and machinery for agriculture and forestry—Serial control and communications data network—Part 6: Virtual terminal”). In such an example, the virtual terminal module 116 may include an implementation of a client of ISO 11783-6, and the display controller 106 may include a corresponding implementation of ISO 11783-6. In a second example, the virtual terminal protocol 118 may be an X Window system protocol, such as X Version 11 or any other version of the X Window system protocol. In a third example, the virtual terminal protocol 118 may be any version of ITU-T (International Telecommunications Union Telecommunications Standardization Sector standards for virtual terminal protocol). In a forth example, the virtual terminal protocol 118 may be an internet protocol that is based on any version of the Hypertext Transfer Protocol (HTTP). In a fifth example, the virtual terminal protocol 118 may be Remote Imaging Protocol Scripting Language, also known as Remote Imaging Protocol, which describes graphical user interfaces using ASCII-text descriptions of vector-drawn graphics and images, along with facilities to create menus and clickable buttons. In a sixth example, the virtual terminal protocol 118 may be Remote Touch Screen Protocol in which the display controller 106 may transmit screen snapshot images to the display device to be drawn directly to a screen comprising the graphical user interface 114 whenever an area of the screen changes. When using the Remote Touch Screen Protocol, the display device 102 does not need to know how user interface controls are drawn or behave.

Data packets 120 transmitted between the display controller 106 and the display device 102 over the vehicle data bus 112 may conform to the virtual terminal protocol 118. Alternatively or in addition, the packets 120 may conform to some other protocol in which the packets 120 describe the graphical user interface 114 displayed by the display device 102.

The gateway 108 may be an apparatus for sharing the graphical user interface 114 of the display device 102 of the vehicle 104 with the remote display device 110, which is accessible from the vehicle 104 over a network 122. The network 122 may include a cellular network, a wireless local area network (WLAN), a WI-FI® (a registered trademark of Wireless Ethernet Compatibility Alliance, Inc. of Austin, Tex.) network, a personal area network (PAN), a wide area network (WAN), a local area network (LAN), the Internet, an Internet Protocol (IP) network, any other communications network, or any combination thereof.

The gateway 108 may include a bus sniffer 124, a network interface 126, a processor 128, and a memory 130. The gateway 108 may plug into or otherwise couple with the vehicle data bus 112.

The bus sniffer 124 may be any module that detects the packets 120 on the vehicle data bus 122. For example, the bus sniffer 124 may be a CAN bus sniffer that detects packets on a CAN bus or any other type of packet sniffer.

The network interface 126 enables communication over the network 122. The network interface 126 may provide physical access to the network 122 and/or provide a low-level addressing system through use of, for example, Media Access Control (MAC) addresses. The network interface 126 may include a network card that is installed inside a computer or other device. Alternatively or in addition, the network interface 126 may include an embedded component as part of a circuit, a computer mother board, a router, an expansion card, a USB (universal serial bus) device, or as part of any other hardware. For example, the network interface 126 may include a cellular network interface, WIFI® compliant network interface, or any other type of network interface.

The memory 130 may be any device for storing and retrieving data or any combination thereof. The memory 130 may include non-volatile and/or volatile memory, such as a random access memory (RAM), a read-only memory (ROM), an erasable programmable read-only memory (EPROM), or flash memory. Alternatively or in addition, the memory 130 may include an optical, magnetic (hard-drive) or any other form of data storage device. The memory 130 may include a user interface generator 132 and a graphics sharing module 134.

The processor 128 may be any device that performs logic operations. The processor 128 may be in communication with the memory 130. The processor 128 may also be in communication with additional components, such as the bus sniffer 124 and the network interface 126. The processor 128 may include a microcontroller, a general processor, a central processing unit, an application specific integrated circuit (ASIC), a digital signal processor, a field programmable gate array (FPGA), a digital circuit, an analog circuit, any other type of processor, or any combination of processors. The processor 128 may include one or more elements operable to execute computer executable instructions or computer code embodied in the memory 130 or in other memory to implement various features. For example, the processor 128 may execute code that implements the features of the user interface generator 132 and/or the graphics sharing module 134.

The user interface generator 132 may be any component that generates a representation 136 of the graphical user interface 114 from information included in the packets 120. For example, the user interface generator 132 may include an implementation of a terminal end of the virtual terminal protocol 118.

The graphics sharing module 134 may be any component that shares the representation 136 of the graphical user interface 114 with the remote display device 110. The graphics sharing module 134 may share the representation 136 of the graphical user interface 114 using any desktop or graphical user interface sharing system 142. A desktop sharing system may share a graphical user interface or screen, which is displayed and/or generated on a first computer, with a second computer over a network. The desktop sharing system 142 may include the graphics sharing module 134 and a corresponding graphics sharing module 138. Examples of a desktop sharing system may include RDP (Remote Desktop Protocol) and VNC® (Virtual Network Computing). VNC® is a registered trademark of ReaIVNC Limited of Cambridge, United Kingdom.

During operation of the system 100 for remote desktop sharing, the display controller 106 may transmit the packets 120 describing the graphical user interface 114 to the display device 102 over the vehicle data bus 112. The virtual terminal module 116 of the display device 102 may process the packets and generate the graphical user interface 114. For example, the virtual terminal module 116 may receive an object pool from the display controller 106 in an example where the virtual terminal protocol 118 complies with ISO 11783-6. The object pool may describe each user interface control to be displayed in the graphical user interface 114. By describing the user interface controls, the packets 120 transporting the object pool may describe the graphical user interface 114. Accordingly, the virtual terminal module 116 may render the graphical user interface 114 based on the object pool received in the packets 120. In addition, the packets 120 may include virtual terminal commands and/or virtual terminal data messages describing updates to the graphical user interface 114. By describing the updates to the graphical user interface 114, the packets 120 may cumulatively describe the graphical user interface 114.

As the packet or packets 120 describing the graphical user interface 114 travel over the vehicle data bus 112 to the display device 102, the bus sniffer 124 may detect the packets 120. The user interface generator 132 may process the packets 120 and/or payloads of the packets 120. From the information in the packets 120, the user interface generator 132 may generate the representation 136 of the graphical user interface 114 in the memory 130 of the gateway 108.

The representation 136 of the graphical user interface 114 may be in any number of formats. In some examples, the representation 136 of the graphical user interface 114 may be an image of the graphical user interface 114 stored in the memory 130. The image of the graphical user interface 114 may include pixel data or other type of image data representing a rendered graphical user interface. In other examples, the representation 136 of the graphical user interface 114 may be a model of the graphical user interface 114 comprising objects from which the image data may be generated. The model of the graphical user interface 114 may be in any form, such as in XML (Extensible Markup Language), XHTML (Extensible HyperText Markup Language), WML (Wireless Markup Language), HTML (HyperText Markup Language), or any other user interface modeling language or structure. Alternatively or in addition, the representation 136 of the graphical user interface 114 may include one or more data messages or data packets compatible with the Internet Protocol (IP), Transmission Control Protocol (TCP)/IP, X.25 data protocol or any another data packet protocol supported by the network 122

The graphics sharing module 134 of the gateway 108 may share the representation 136 of the graphical user interface 114 with the remote display device 110. The corresponding graphics sharing module 138 that is included in the remote display device 110 may generate a copy 140 of the graphical user interface 114. The remote display device 110 may display the copy 140 of the graphical user interface 114.

Over time, the graphical user interface 114 may be updated. For example, when the graphical user interface 114 and/or the display device 102 receives navigational input from a user, or when the display controller 106 determines updates are needed due to data received by the display controller 106 from a sensor and/or from an electronic control unit (ECU). The descriptions of user interface updates may be transmitted in the packets 120 from the display device 102 to the display controller 106 and/or from the display controller 106 to the display device 102. For example, data may be entered into a field in the graphical user interface 114 at the display device 102. The display device 102 may transmit the entered data to the display controller 106. The entered data and an identity of the field in which the data was entered may be transmitted by the display device in one or more of the packets 120 to the display controller 106. In another example, the display controller 106 may transmit sensor data and an identity of a user interface control in one or more of the packets 120 to the display device 102. The display device 102 may update the user interface control in the graphical user interface 114 to display the sensor data.

As indicated above, the bus sniffer 124 may detect the packets 120 that include the descriptions of the user interface updates. Based on information in the packets 120 that include the descriptions of the user interface updates, the user interface generator 132 may update the representation 136 of the graphical user interface to reflect the user interface updates. Accordingly, the bus sniffer 124 together with the graphics sharing module 134 may recreate screens in the memory 130 that are displayed in the display device 102. Furthermore, when the graphics sharing module 134 generates the representation 136 of the graphical user interface 114, the graphics sharing module 134 may generate a complete version of the representation 136 of the graphical user interface 114 and/or update a previously generated version of the representation 136 of the graphical user interface 114.

The graphics sharing module 134 may propagate the user interface updates made to the representation 136 of the graphical user interface to the remote display device 110. For example, the graphics sharing module 134 may transmit recreated screens from the memory 130 of the gateway 108 to the remote display device 110. The copy 140 of the graphical user interface 114 displayed by the remote display device 110 is accordingly updated to match the graphical user interface 114 displayed by the display device 102.

In some examples, the copy 140 of the graphical user interface 114 cannot be updated by a user at the remote display device 110. In alternative examples, the copy 140 of the graphical user interface 114 may be updated by a user at the remote display device 110.

The systems 100 and 142 may be implemented with additional, different, or fewer components. For example, the system 100 may include just the bus sniffer 124, the network interface 126, the processor 128, and the memory 130 comprising the user interface generator 132 and graphics sharing module 134.

Each component may include additional, different, or fewer components. For example, although the gateway 108 illustrated in FIG. 1 includes the bus sniffer 124, the gateway 108 may not include the bus sniffer 124. The bus sniffer 124 may be a separate discrete component that is detachably coupled to the vehicle data bus 112 and to the gateway 108. In another example, the gateway 108 may not include the network interface 126. In the example illustrated in FIG. 1, the gateway 108 does not include a display device. In other examples, the gateway 108 may include a display device. The display device on the gateway 108 may be used for troubleshooting purposes, for example. Alternatively or in addition, the display device in the gateway 108 may provide an operator with a view of the graphical user interface 114 that is displayed on the vehicle display device 102 elsewhere on the vehicle 104.

In some examples, the packets 120 may conform to a protocol that is not a virtual terminal protocol. In such examples, the display device may include a rendering module that is not the virtual terminal module 116 illustrated in FIG. 1. The rendering module may generate the graphical user interface 114 from the information included in the packets 120. The user interface generator 132 of the gateway 108 may also interpret the information in the packets 120, and generate the representation 136 of the graphical user interface 114.

The systems 100 and 142 may be implemented in many different ways. Each module, such as the virtual terminal module 116, the bus sniffer 124, the user interface generator 132, and the graphics sharing modules 134 and 138, may be hardware or a combination of hardware and software. For example, each module may include an application specific integrated circuit (ASIC), a Field Programmable Gate Array (FPGA), a circuit, a digital logic circuit, an analog circuit, a combination of discrete circuits, gates, or any other type of hardware or combination of hardware. Alternatively or in addition, each module may include memory hardware, such as a portion of the memory 130, for example, that comprises instructions executable with the processor 128 or other processor to implement one or more of the features of the module. When any one of the module includes the portion of the memory that comprises instructions executable with the processor, the module may or may not include the processor. In some examples, each module may just be the portion of the memory 130 or other physical memory that comprises instructions executable with the processor 128 or other processor to implement the features of the corresponding module without the module including any other hardware. Because each module includes at least some hardware even when the included hardware comprises software, each module may be interchangeably referred to as a hardware module, such as the virtual terminal hardware module 116, the bus sniffer hardware 124, the user interface generator hardware 132, and the graphics sharing hardware module 134 or 138.

Although some features are shown stored in computer-readable memories (for example, as logic implemented as computer-executable instructions or as data structures in memory), all or part of the system 100 and its logic and data structures may be implemented in an application specific integrated circuit (ASIC), a Field Programmable Gate Array (FPGA), a circuit, a digital logic circuit, an analog circuit, a combination of discrete circuits, gates, or any other type of hardware or combination of hardware. In addition, computer-readable memories, such as the memory 130 of the gateway 108, may include any type of memory including computer-readable storage media hard disks, floppy disks, CD-ROMs, or any other type of storage medium or storage media.

The processing capability of the systems 100 and 142 may be distributed among multiple entities, such as among multiple processors and memories, optionally including multiple distributed processing systems. Parameters, databases, and other data structures may be separately stored and managed, may be incorporated into a single memory or database, may be logically and physically organized in many different ways, and may implemented with different types of data structures such as linked lists, hash tables, or implicit storage mechanisms. Logic, such as programs or circuitry, may be combined or split among multiple programs, distributed across several memories and processors, and may be implemented in a library, such as a shared library, or a combination thereof.

The vehicle 104 may be any type of vehicle, such as an automobile, a bus, a train, an industrial vehicle, an agricultural vehicle, a ship, an aircraft. Alternatively or in addition, the vehicle 104 may refer to an attachment to a vehicle, such as a trailer or a vehicle-hitchable device. More generally, the system 100 for remote desktop sharing of the display device 102 may not be in a vehicle or have anything to do with a vehicle. For example, the system 100 may be included in an appliance, such as a washer or dryer, where the display device 102 displays information about the appliance. The vehicle data bus 112 may be simply a data bus. The data bus 112 may include a communications network configured to facilitate communication between microcontrollers and devices without a host computer. The data bus may be configured to facilitate adding and removing devices that read and/or write data from and/or to the data bus. Examples of the data bus may include a controller area network (CAN) bus, a local interconnect network (LIN), an ISO 9141 compliant network, a J1850 compliant network, and an Ethernet network.

The gateway 108 may be constructed in any number of form factors. For example, the gateway 108 may be in the form of an ECU or other vehicle control unit that couples to the vehicle data bus 112. The gateway 108 may be in the form of a small device integrated with a plug that couples with a socket, where the socket receives the plug and electrically couples the gateway 108 with the vehicle data bus 112.

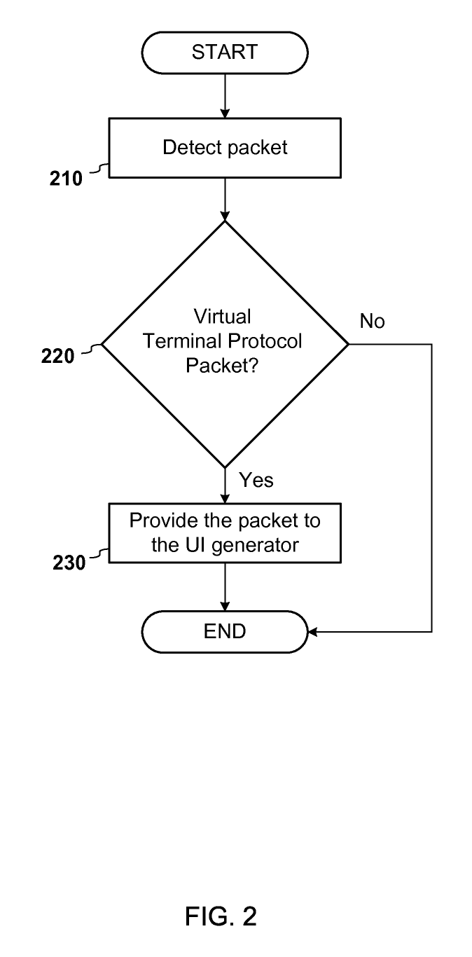

FIG. 2 illustrates a flow diagram of example logic of the bus sniffer 124. The operations may begin with detection (210) of the packet 120 on the vehicle data bus 112. A determination (220) may be made whether the packet 120 is a packet transmitted as part of the virtual terminal protocol 118. In one example, the bus sniffer 124 may determine that the packet 120 is a virtual terminal protocol packet based on reading header information, a frame header, a preamble data packet, a packet type identifier, or a format identifier from the packet 120 on the vehicle data bus 112. The bus sniffer 124 may comprise, for example, a packet data receiver (not shown), a packet data transceiver (not shown), and/or a data processor (not shown) programmed with software instructions that convert, transform and/or recass one or more received virtual terminal protocol packets into one or more transformed data packets compatible with the Internet Protocol (IP), Transmission Control Protocol (TCP)/IP, the X.25 data protocol, or any other data packet protocol supported by the network 112.

If the packet 120 is a virtual terminal protocol packet, then the packet 120 may be provided (230) to the user interface generator 132. Alternatively, if the packet 120 is not a virtual terminal protocol packet, then the packet 120 may be ignored and/or not provided to the user interface generator 132. The logic of the bus sniffer 124 may end by, for example, returning to the operation of the detection (210) of the packet(s) 120.

The logic of the bus sniffer 124 may include additional, different, or fewer operations than illustrated in FIG. 2. More generally, instead of determining (220) whether the packet 120 is a virtual terminal protocol packet, a determination may be made whether the packet 120 describes the graphical user interface 114 displayed by the display device 102.

In addition to, or instead of, determining (220) whether the packet 120 is a virtual terminal protocol packet, a determination may be made whether the packet 120 is addressed to the display device 102. In some examples, the packet 120 may be broadcast (not unicast) over the vehicle data bus 112. In such examples, no determination may be made whether the packet 120 is addressed to the display device 120. In still other examples, all of the packets 120 detected by the bus sniffer 124 may be provided to the user interface generator 132. The operations may be executed in a different order than illustrated in FIG. 2.

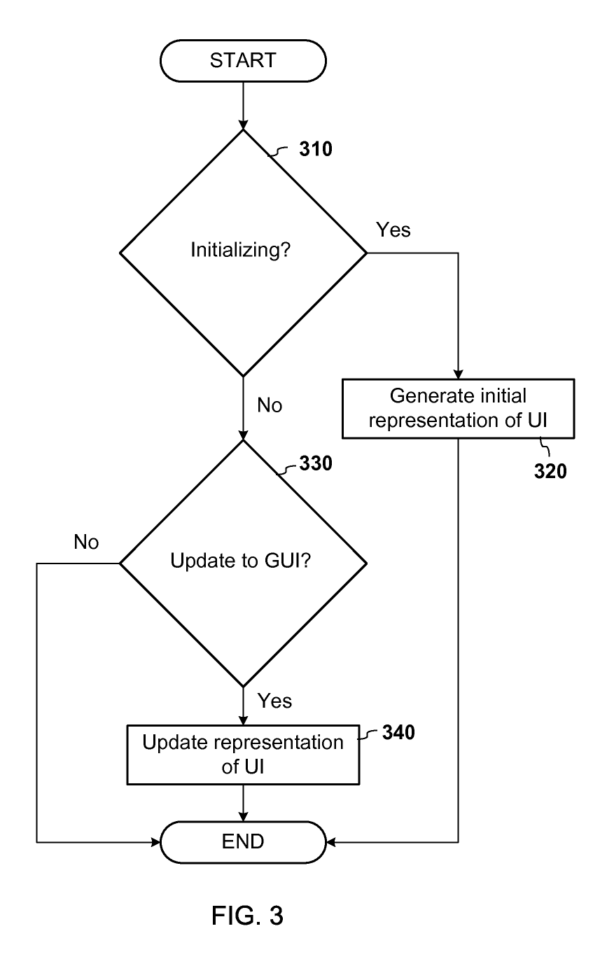

FIG. 3 illustrates a flow diagram of example logic of the user interface generator 132 of the gateway 108. The operations may begin with a determination (310) whether the graphical user interface 114 displayed on the display device 102 is being initialized based on the packet or packets 120 detected by the bus sniffer 124.

If the graphical user interface 114 is being initialized, then the representation 136 of the graphical user interface 114 may be generated (320) from initialization data. For example, the object pool may be extracted from the packet or packets 120, and the representation 136 of the graphical user interface 114 may be generated in the memory 130 of the gateway 108 from the object pool.

Alternatively, if the graphical user interface 114 is not being initialized, then a determination (330) may be made whether the graphical user interface 114 is being updated based on the packet or packet 120 detected by the bus sniffer 124. If the graphical user interface 114 is being updated, then the representation 136 of the graphical user interface 114 may be updated (340). For example, if the packet 120 indicates that a value displayed in a user interface control changes, then the value in the user interface control in the representation 136 of the graphical user interface 114 may be updated. Operations may end by, for example, returning to determine (310) whether the graphical user interface 114 is being initialized.

The logic of the user interface generator 132 may include additional, different, or fewer operations than illustrated in FIG. 3. For example, a determination may be made whether the packet 120 detected by the bus sniffer 124 is a type of packet that describes the graphical user interface 114. The operations may be executed in a different order than illustrated in FIG. 3.

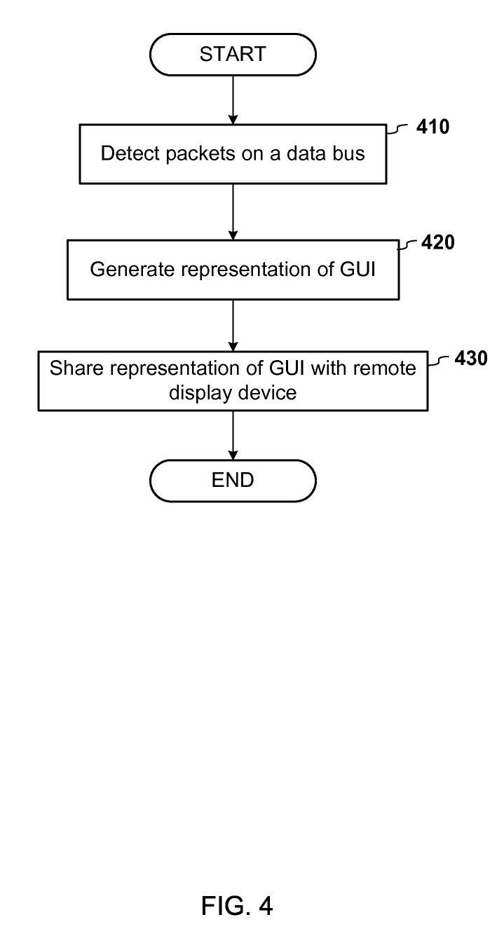

FIG. 4 illustrates a flow diagram of example logic of the system 100. The packets 120 on the vehicle data bus 112—or data bus more generally—may be detected (410) with the bus sniffer 124, where the packets 120 are transmitted by the display controller 106 to the display device 102 over the data bus. The packets 120 may include information describing the graphical user interface 114 displayed in the display device 102. The representation 136 of the graphical user interface 114 may be generated (420) in the memory 130 from the packets 120. The representation 136 of the graphical user interface 114 in the memory 130 may be shared (430) with the remote display device 110 over the network 122 with the desktop sharing system 142. The remote display device 110 may display the copy 140 of the graphical user interface 114 based on the representation 136 of the graphical user interface 114 shared by the desktop sharing system 142.

Operations may end, for example, by returning to the operation in which the packets 120 are detected (410). Alternatively or in addition, operations may end by checking for any packet or packets included in the packets 120 indicating that changes were made to the graphical user interface 114 on the display device. The logic may include additional, different, or fewer operations than illustrated in FIG. 4. The operations may be executed in a different order than illustrated in FIG. 4.

The system and method is well suited for allowing an operator or service technician to use a smart phone, cellular phone, wireless device, or a computer connected to the Internet to observe or monitor (remotely or at the vehicle) one or more screens of a graphical user interface of a vehicle for servicing of the vehicle. The network 122 may comprise a wireless network that communicates with a server, which in turn communicates with a computer of a service technician over the Internet, for example. Although the method and system discloses remote monitoring of the graphical user interface 114 at the remote display device 110, in alternate embodiments a remote user can control or program certain parameters of the vehicle remotely via the network 122 and the remote display device 110, or via a separate communication between the gateway 108 and the remote display device 110.

All of the discussion, regardless of the particular implementation described, is exemplary in nature, rather than limiting. For example, although selected aspects, features, or components of the implementations are depicted as being stored in memories, all or part of systems and methods consistent with the innovations may be stored on, distributed across, or read from other computer-readable storage media, for example, secondary storage devices such as hard disks, floppy disks, and CD-ROMs; or other forms of ROM or RAM. The computer-readable storage media may be non-transitory computer-readable media, which includes CD-ROMs, volatile or non-volatile memory such as ROM and RAM, or any other suitable storage device. Moreover, the various modules functionality is but one example of such functionality and any other configurations encompassing similar functionality are possible.

The respective logic, software or instructions for implementing the processes, methods and/or techniques discussed above may be provided on computer-readable media or memories or other tangible media, such as a cache, buffer, RAM, removable media, hard drive, other computer readable storage media, or any other tangible media or any combination thereof. The tangible media may include various types of volatile and nonvolatile storage media. The functions, acts or tasks illustrated in the figures or described herein may be executed in response to one or more sets of logic or instructions stored in or on computer readable media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like. In one embodiment, the instructions may be stored on a removable media device for reading by local or remote systems. In other embodiments, the logic or instructions may be stored in a remote location for transfer through a computer network or over telephone lines. In yet other embodiments, the logic or instructions are stored within a given computer, central processing unit (“CPU”), graphics processing unit (“GPU”), or system.

Furthermore, although specific components are described above, methods, systems, and articles of manufacture consistent with the innovation may include additional, fewer, or different components. For example, a processor may be implemented as a microprocessor, microcontroller, application specific integrated circuit (ASIC), discrete logic, or a combination of other type of circuits or logic. Similarly, memories may be DRAM, SRAM, Flash or any other type of memory. Flags, data, databases, tables, entities, and other data structures may be separately stored and managed, may be incorporated into a single memory or database, may be distributed, or may be logically and physically organized in many different ways. The components may operate independently or be part of a same program or apparatus. The components may be resident on separate hardware, such as separate removable circuit boards, or share common hardware, such as a same memory and processor for implementing instructions from the memory. Programs may be parts of a single program, separate programs, or distributed across several memories and processors.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

While various embodiments of the innovation have been described, it will be apparent to those of ordinary skill in the art that many more embodiments and implementations are possible within the scope of the innovation. Accordingly, the innovation is not to be restricted except in light of the attached claims and their equivalents.

What is claimed is:

1. A system for remote desktop sharing of a vehicle display device, the system comprising:
a bus sniffer configured to detect packets on a vehicle data bus as the packets pass over the vehicle data bus between a display controller and a first display device, the packets comprising information that describes a graphical user interface displayed in the first display device;
a memory;
a user interface generator configured to generate a representation of the graphical user interface in the memory from the packets detected by the bus sniffer;
a network interface configured to communicate over a network to a second display device; and
a graphics sharing module configured to communicate the representation of the graphical user interface to the second display device over the network via the network interface, wherein the second display device displays a copy of the graphical user interface based on the representation of the graphical user interface communicated to the second display device by the graphics sharing module.

2. The system of claim 1, wherein the bus sniffer, the memory, the user interface generator, the network interface, and the graphics sharing module are included in a gateway.

3. The system of claim 1, wherein the network interface is further configured to communicate the representation of the graphical user interface wirelessly to the second display device.

4. The system of claim 1, wherein the packets conform to a virtual terminal protocol.

5. The system of claim 4, wherein the virtual terminal protocol defines and/or controls one or more user interface controls in the graphical user interface over the vehicle data bus.

6. The system of claim 1, wherein the vehicle data bus includes a Controller Area Network bus.

7. The system of claim 1, wherein the graphics sharing module is configured to communicate the representation of the graphical user interface as part of a desktop sharing system.

8. The system of claim 1, wherein the representation of the graphical user interface includes image data that represents a rendered graphical user interface.

9. An apparatus for remote desktop sharing, the apparatus comprising:
a bus sniffer configured to detect packets transmitted by a display controller over a data bus to a first display device, the packets comprising information related to a graphical user interface displayed in the first display device;
a memory;
a user interface generator configured to generate a representation of the graphical user interface in the memory from the packets detected by the bus sniffer; and
a graphics sharing module configured to communicate the representation of the graphical user interface from the apparatus to the second display device over a network, wherein the second display device displays a copy of the graphical user interface based on the representation of the graphical user interface communicated to the second display device by the graphics sharing module.

10. The apparatus of claim 9, wherein the representation of the graphical user interface includes image data that represents a rendered graphical user interface.

11. The apparatus of claim 9, wherein the user interface generator is further configured to update, based on the packets detected by the bus sniffer, the representation of the graphical user interface in the memory to reflect an update made to the graphical user interface displayed on the first display device.

12. The apparatus of claim 9, wherein the network includes a wireless network.

13. The apparatus of claim 9, wherein the user interface generator is further configured to extract an object pool from the packets detected on the data bus, wherein the object pool describes each user interface control displayed in the graphical user interface.

14. The apparatus of claim 13, wherein the user interface generator is configured to generate the representation of the graphical user interface in the memory from the object pool.

15. The apparatus of claim 9, wherein the bus sniffer is configured to couple to the data bus between the first display device and the display controller.

16. A method to remotely share a desktop, the method comprising:
detecting packets on a data bus with a bus sniffer that are transmitted by a display controller to a first display device over the data bus, the packets comprising information describing a graphical user interface displayed in the first display device;
generating a representation of the graphical user interface in a memory from the packets; and
sharing the representation of the graphical user interface with a second display device over a network with a desktop sharing system, wherein the second display device displays a copy of the graphical user interface based on the representation of the graphical user interface shared by the desktop sharing system.

17. The method of claim 16, wherein generating the representation of the graphical user interface comprises converting information in the packets to image data that represents a rendered graphical user interface.

18. The method of claim 16, wherein generating the representation of the graphical user interface comprises extracting an object pool from the packets, the object pool comprising an object for each user interface control displayed in the graphical user interface.

19. The method of claim 18, wherein generating the representation of the graphical user interface further comprises converting the object pool into image data that represents an image of the graphical user interface.

20. The method of claim 15, wherein generating the representation of the graphical user interface further comprises generating the representation of the graphical user interface during initialization of the graphical user interface and updating the representation of the graphical user interface when the graphical user interface is updated.
